SEQUENCE LISTING (1 sequence)

SEQ ID NO: 1 - DNA, 142 bp, Artificial
  Artificial construct
tgtagagacgtcgacagctcacactcgcatacgagactatagtacgtatcgatacgtcatctgatcacgcacgcatatgtagagctagtgagcacgtcgatatgacatgatagcagtcgctaggtcagatcgttcgactagg

(19) United States
(12) Patent Application Publication
(10) Pub. No.: US 2014/0216935 A1
(43) Pub. Date: Aug. 7, 2014

(54) Dielectrophoretic Tweezers as a Platform for Molecular Force Spectroscopy in a Highly Parallel Format

(71) Applicant: Lehigh University, Bethlehem, PA (US)

(72) Inventor: Dmitri Vezenov, Belhlehem, PA (US)

(73) Assignee: Lehigh University, Bethlehem, PA (US)

(21) Appl. No.: 13/962,193

(22) Filed: Aug. 8, 2013

Related U.S. Application Data
(60) Provisional application No. 61/680,984, filed on Aug. 8, 2012.

(51) Int. Cl. G01Q 10/04

(52) U.S. Cl. CPC G01Q 10/04
USPC 204/547; 204/643

(57) ABSTRACT

Provided herein are methods of performing force spectroscopy, the methods comprising the steps of providing dielectrophoretic tweezers having at least one set of macroscopic electrodes, at least one of the electrodes having a microfabricated dielectric structure comprising a microwell; depositing force probes on a surface; binding the force probes to molecules on the surface; and applying voltage across set of macroscopic electrodes to thereby manipulate the molecules. Also provided are novel apparatus for performing force spectroscopy, the apparatus comprising dielectrophoretic tweezers having at least one set of macroscopic electrodes, at least one of the electrodes having a microfabricated dielectric structure comprising a microwell.

### CROSS-REFERENCE TO RELATED APPLICATIONS

This application claims priority to U.S. Provisional Patent Application Ser. No. 61/680,984 filed Aug. 8, 2012.

### GOVERNMENT LICENSE STATEMENT OF INTEREST

This invention was made with government support under Grant/Contract No. 221 HG004141 awarded by the National Institutes of Health (NIH). The govemment has certain rights in the invention

### BACKGROUND

In recent years, molecular force spectroscopy (MFS) has become a major research tool for studying inter- and intra-molecular forces, including biomolecular recognition, the energy landscapes of protein folding, and energetic barriers of the conformational changes in biomolecules. A typical force spectroscopy experiment often involves binding one end of a molecule to a surface of a rigid support and the other to a mobile force probe (commonly a tip of an atomic force microscope (AFM) or a microsphere used in optical tweezers) followed by controlled displacement of the probe to obtain a force-extension curve.

In MFS experiments, hundreds of measurements must be collected on the same system in order to provide sufficient data for averaging and statistics or to uncover multiple unique mechanical pathways or states of the system. This experimental process is often time-consuming and cannot be readily extended to a parallel format, especially if chemically-distinct molecules are to be analyzed, since a different optical trap or AFM tip will be needed for multiple molecular species. Alternatively, magnetic tweezers provide an opportunity to acquire large amounts of data by simultaneously applying a magnetic field to multiple magnetic colloidal probes, thereby applying a controlled force in parallel. However, the challenges in this case are the difficulty in fabrication of the monodisperse superparamagnetic probes, need for close proximity of the magnetic field concentrator to achieve high forces, and limited sample area where uniform force application can be achieved.

For all of the above reasons, there exists a long-standing, continuing and unmet need for a massively parallel MFS technique in which the force on the probes is evenly applied to all the probes in the system.

### SUMMARY

Provided herein are methods of performing force spectroscopy, the methods comprising the steps of providing dielectrophoretic tweezers having at least one set of macroscopic electrodes, at least one of the electrodes having a microfabricated dielectric structure comprising a microwell; depositing force probes on a surface; binding the force probes to molecules on the surface; and applying voltage across set of macroscopic electrodes to thereby manipulate the molecules. Also provided are novel apparatus for performing force spectroscopy, the apparatus comprising dielectrophoretic tweezers having at least one set of macroscopic electrodes, at least one of the electrodes having a microfabricated dielectric structure comprising a microwell.

Other embodiments will be apparent from the following description, claims, and figures.

### BRIEF DESCRIPTION OF THE DRAWINGS

The following brief description of the drawings is made:

FIG. 1 is a graph illustrating calculated frequency dependence typical to a dielectric particle in an embodiment in accordance with the present invention.

FIGS. 2(a)-2(d) are schematics illustrating various cell designs for DEP tweezers in an embodiment in accordance with the present invention.

FIGS. 3(a)-3(c) are schematics illustrating various cell designs and results for DEP tweezers in an embodiment in accordance with the present invention.

FIG. 4 is a graph illustrating simulation results of DEP force as a function of electrode separation in an embodiment in accordance with the present invention.

FIG. 5 is a graph illustrating the number of polystyrene microspheres remaining on the electrode as the frequency of the applied field is changed in DI water in an embodiment in accordance with the present invention.

FIG. 6(a)-6(l) are schematics and associated graphs illustrating various cell geometry designs and results for DEP tweezers in an embodiment in accordance with the present invention.

FIG. 7(a)-7(c) are epi-fluorescence images and associated graphs illustrating results for DEP tweezers in an embodiment in accordance with the present invention.

FIGS. 8(a)-8(b) schematics and associated graphs illustrating comparisons among various cell geometry designs and results for DEP tweezers in several an embodiments in accordance with the present invention.

FIG. 9 is a schematic of a reaction scheme of a probe and ssDNA attachment to a gold electrode in accordance with the present invention.

FIGS. 10(a)-10(c) are TIRF images and associated graphs illustrating results for DEP tweezers in an embodiment in accordance with the present invention.

FIGS. 11(a)-11(d) are schematics and associated graphs and TIR images illustrating designs and results for DEP tweezers in embodiments in accordance with the present invention.

FIGS. 12(a)-12(c) are schematics illustrating various cell geometries for microfluidic cell counting in an embodiment in accordance with the present invention.

FIGS. 13(a)-13(c) are images from bright field transmission illustrating polymer microspheres trapped in wells in an embodiment in accordance with the present invention.

FIGS. 14(a)-14(b) are stained cell photo images and associated graphs illustrating results for DEP tweezers in an embodiment in accordance with the present invention

### DETAILED DESCRIPTION

Described herein are methods and apparatus for a massively parallel MFS technique system based on dielectrophoresis (DEP). in which the force on the probes is evenly applied to all the probes in the, We show that by perturbing the electric field with dielectric microstructures one can generate DEP forces in the range of several hundred piconewtons acting on microscopic probes across a macroscopic sample area. The magnitude and direction of the force can be manipulated by controlling the amplitude and frequency of the electric field.

We demonstrated the application of a simple electrode geometry for dielectrophoresis (DEP) on colloidal probes as a form of molecular force spectroscopy in a highly parallel format. The electric field between parallel plates is perturbed with dielectric microstructures, generating uniform DEP forces on colloidal probes in the range of several hundred piconewtons across a macroscopic sample area. We determined the approximate crossover frequency between negative and positive DEP using electrodes without dielectric microstructures—a simplification over standard experimental methods involving quadrupoles or optical trapping. 2D and 3D simulations of the electric field distributions validated the experimental behavior of several of our DEP tweezers geometries and provided insight into potential improvements. We applied the DEP tweezers to the stretching of a short DNA oligomer and detected its extension using total-internal reflection fluorescence microscopy. The combination of a simple cell fabrication, a uniform distribution of high axial forces, and a facile optical detection of our DEP tweezers makes this form of molecular force spectroscopy ideal for highly parallel detection of stretching or unbinding kinetics of biomolecules.

In this application, we report an implementation of dielectrophoretic tweezers using parallel flat electrodes to manipulate an array of polymer force probes. Instead of fabricating complex micro-electrode arrays to generate the field gradients necessary to manipulate particles with DEP (a common approach for applications of dielectrophoresis with biological samples),16-23 we used a single set of macroscopic electrodes to generate high electric field gradients in the vicinity of the sample surface by using simple microfabricated dielectric structures (microwells) on one of the electrodes. Near a planar electrode, the force probe itself (a dielectric microsphere) can also serve as such a microstructure thereby creating the electric field gradient used to apply a force. We evaluated the performance characteristics of several possible designs for DEP tweezers using numerical analysis and then used this chip-based force spectroscopy technique to stretch single stranded DNA (ssDNA). Since we are using large area metal surfaces as electrodes, we can achieve a uniform potential distribution and reproducible field gradients throughout the whole working area of the device, thus, making this approach ideally suited for highly parallel measurements.

Theoretical Background of DEP

The DEP phenomenon occurs when a dielectric material (in our case, a polymer microsphere) is exposed to a non-uniform electric field. The electric field polarizes both the dielectric particle and the medium around it to different extents and the material with the greater polarization (either the particle or the surrounding medium) will move towards the region of the higher electric field in order to lower the energy of interaction with the external electric field. To characterize the force acting on a probe in such a system, we can write the time averaged DEP force as:

F̅=2πR³∈ₘRe(CM)∇Eᵣₘₛ² (1)

where R is the radius of the particle, ∈ₘ is the dielectric constant of the medium, Re(CM) is the real part of the Clausius-Mossotti (CM) factor,²⁴ and ∇Eᵣₘₛ² the gradient of the squared electric field. The CM factor describes the total redistribution of charge throughout the system and takes into account the polarizabilities and the conductivities of both the particle and the medium.

$$CM ( {\tilde{ɛ}}_{p} , {\tilde{ɛ}}_{m} ) = \frac{{\tilde{ɛ}}_{p} - {\tilde{ɛ}}_{m}}{{\tilde{ɛ}}_{p} + 2 {\tilde{ɛ}}_{m}} , \qquad ( 2 )$$

where \tilde{∈}ₚ and \tilde{∈}ₘ are the complex dielectric constant of the particle and the medium, respectively. The complex dielectric constants depend on both the conductivity (σ) (of the polymer itself and the electric double layer²⁵⁻²⁸) and the relative permittivity (∈ᵣ) of the material, as well as the frequency of the AC field (f) and is written as:

$$\tilde{ɛ} = {ɛ}_{0} {ɛ}_{r} - ι \frac{σ}{2 π f} . \qquad ( 3 )$$

An important aspect of the CM factor is that it introduces frequency dependence to the DEP force that one can potentially use to tune the magnitude of the DEP force or even reverse its direction. When Re(CM) value is positive, the particle will move towards the high electric field, and the effect is termed positive DEP. In contrast, negative DEP occurs when the value of the real part of the CM factor is negative, inducing the particle to move towards the low electric field. As a result, this physical relationship can be exploited to either push or pull on a polymer microsphere in an aqueous medium.

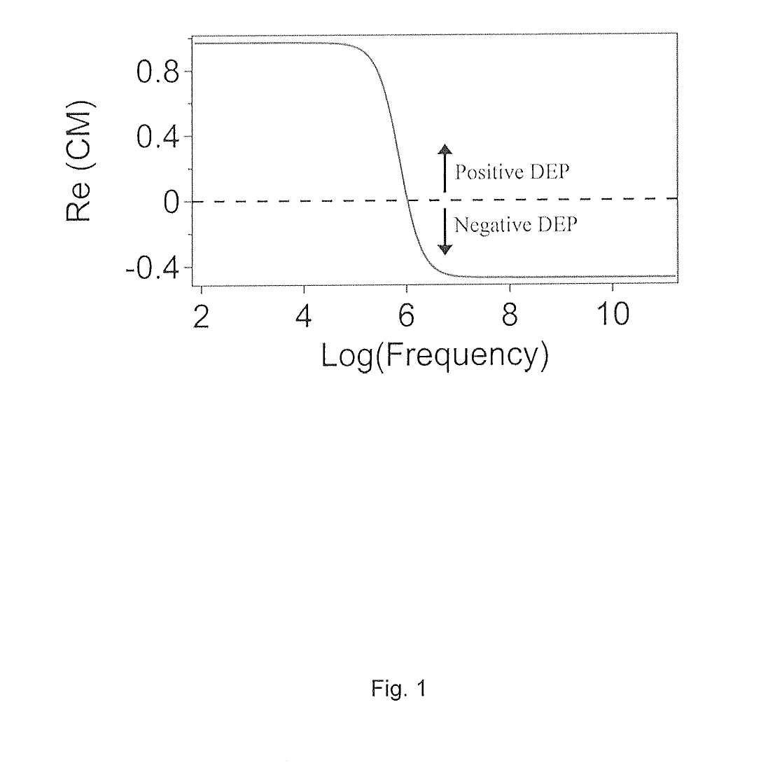

FIG. 1 shows the calculated frequency dependence of the CM factor expected for the polymer-only microspheres used throughout this manuscript, in an ideal water environment assuming formation of an electric double layer. According to Equations 2 & 3, the frequency necessary to switch the DEP direction from positive to negative for colloidal probes in aqueous solutions lies around the 1 MHz range, which is easily obtainable with off-the-shelf function generators. This swappable force direction enables application of the proposed DEP tweezers in a wide range of different systems: for example, one can use the tweezers to trap and then release polymer particles or whole cells.

FIG. 1 shows calculated frequency dependence of the real part of the Clausius-Mossotti factor for a dielectric particle typical to our system (∈ₘ/∈₀=78, σₘ=10⁻⁵ S·m⁻¹; ∈ₚ/∈₀=3.0, σp=10⁻³S·m⁻¹). The probe experiences a positive DEP force when the frequency is below 1 MHz, while a negative DEP force acts on a probe when the frequency of applied AC field is above 1 MHz.

System Design

To produce a DEP force, one needs to form electric field gradient in the sample volume of interest. Commonly, closely positioned micropatterned electrodes are used to create a non-uniform electric field capable of generating a DEP force.29-33 As an alternative to this method, it is possible to perturb the electric field with a dielectric structure (including the particle that one is trying to manipulate). 34-37

A system of two parallel large area electrodes produces a uniform electric field and no DEP force is expected for a single microsphere suspended in the space between these electrodes. When the sphere is close to the surface of one of the electrodes (distance<<particle size), an imbalance of the field gradient is created on the two sides of the probe (facing the solution and facing the electrode), generating a net DEP force normal to the substrate. When the sphere moves further away from the electrode's surface (on the order of the probe radius) the classical picture emerges and the DEP force disappears. This phenomenon is ideally suited for use of large (micron size) probes to pull on molecules having contour lengths on the order of hundreds of nanometers attached to flat surfaces, since the probe will always remain close to the surface compared to its size. An assembly of microspheres on a planar electrode due to DEP forces has been previously investigated, 38-41 although only lateral inter-particle forces were of interest in this case.

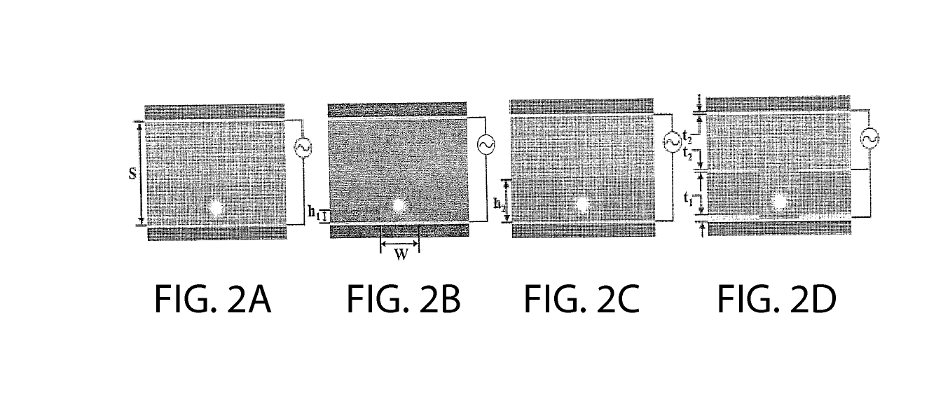

Flat electrodes as described above are not always ideal to conduct parallel force spectroscopy experiments, because (i) they do not provide for the optimization of the magnitude of the forces and (ii) they create a random array of probes that lack the organization to process data on a very large scale. To maximize control over the DEP forces, as well as introduce order to the array, we can consider the creation of a patterned electrode array and the perturbation of the electric field with a dielectric structure integrated into the large area electrode. Creating patterned electrode arrays may involve sophisticated fabrication methods and raises possible alignment issues (e.g. position of the probe with respect to electrode will affect the magnitude of the force), thus increasing the cost and degree of difficulty needed to fabricate and operate a cell for DEP tweezers working on a large scale. Alternatively, to perturb the electric field, a dielectric obstacle can be placed inside the otherwise uniform field, 42, 43 such as a microfabricated solid structure, for example, a microwell array. For these reasons, we chose to focus solely on the design of dielectric patterns to form the electric field gradient. FIG. 2 diagrams four such electrode configurations all capable of delivering DEP force. We have conducted theoretical simulations and experiments to characterize the DEP forces for all four configurations of the electrodes.

FIG. 2 shows various cell designs for DEP tweezers. (a) Geometry A: A probe above a flat electrode. (b) Geometry B: A probe in a shallow microwell fabricated on top of an electrode (well depth h₁<bead diameter). (c) Geometry C: A probe inside a deep microwell fabricated on top of an electrode (well depth h₂>bead diameter). (d) Geometry D: A microwell on top of a thick gold layer (thickness t₁=135 nm), whose primary purpose is to block the light from entering the photoresist layer making layout suitable for TIRFM detection. The thin gold layers (thickness t₂=14 nm) act as the electrodes. The standard dimensions for all wells used in this work had w=4.2 μm and s=24 μm (unless varied on purpose). The center-to-center distance for the wells was 44.2 μm.

There are several advantages to the use of the microwell format shown in FIG. 2b-d. First, when the probe is positioned inside a well, there are several interfaces where dielectric constant experiences a significant jump. When potential is applied between two planar gold electrodes, the electric field will be strongly perturbed by the dielectric contrast of three different materials (the probe, the medium, and the microwell), resulting in a high electric field gradient inside the well. Second, this approach to generation of the DEP force only relies on conventional fabrication of the microwell arrays by a single step contact photolithography. Third, the wells will also provide a high degree of order for arrangement of the probes on the surface of the DEP cell to simplify indexing of the array and subsequent analysis. Finally, placement of the microspheres inside individual wells results in the added stability of the setup during fluid exchanges, which may be necessary to conduct biochemical reactions/binding without removing the probes. The shear force on a single force probe is minimized during exchange (flow) of the solution above the surface of the microwell array.

In order to create a system for molecular force spectroscopy that can accommodate a large number of individual experiments and applies an adjustable DEP force to each molecule at the same time, we mounted a DEP chip inside a fluid cell that is accessible for optical observations and enables controlled dosing of microscopic force probes and reagents. Wide field optical microscopy ensures simultaneous observations of multiple probes. Integration with microfluidics minimizes the volume of reagents used, so that the total cost of conducting single molecule pulling experiments is greatly reduced, which is important if the DEP tweezers are to be used in a bioanalysis assay.

Numerical and Experimental Methods

Numerical simulation. To investigate the magnitude of the DEP force in each variation of the DEP tweezers arrays, we used a finite element method software package (COMSOL Multiphysics, Burlington, Mass.). Due to the constraints of the size and complexity of the problem, and demands on computational time for the simulations of the electric field in the space around the probe and electrodes, the majority of our simulations were conducted as two dimensional (2D) approximations. In order to examine the accuracy of 2D simulation, we compared results from four types of simulations: 2D, reduced 3D (2D with axial symmetry), and full 3D with a round or square well (see supporting information (SI), section SI). In both 2D and 3D simulations, we solved a variant of Poisson's equation for potential distribution:

−∇·(∈₀∇V−P)=ρ (4)

in the electrostatics module. Here V is the electric potential, P is the electric polarization vector, and the ρ is the electric charge density.

A standard simulation consisted of two 44.2 μm wide electrodes separated by 20 μm (unless specified otherwise) of deionized water. On the lower electrode 4.2 μm wide dielectric wells (consisting of SU-8) were simulated with depths of 2, 4, 6, and 8 μm with rounded corners (0.2 μm curvature) to reduce sharp edge effects not present in experiment. To represent the format of an array, the left and right boundaries of the cell were set to a periodic condition to repeat the structure infinitely. To simulate the force on a probe a PMMA sphere was place inside the well just above the surface of the electrode. For the entire system physical values for the relative dielectric constants were used. A quasi-static potential field was simulated from the Laplace equation ∇²V=0 (V is the voltage) for surface potentials of +5 and −5 V. The 3D calculations share the same parameters with the 2D simulation. Both a square shaped well and a round shaped well were modeled in 3D.

We investigated the accuracy of two different integration methods for derivation of a DEP force (see section S1 in SI for details). Besides using the first order approximation—effective dipole moment (EDA) model, which results in Equation 1, we also used a rigorous model and obtained the force by integration of the Maxwell stress tensor (MST) over the surface of the probe. 44 The general form for the time-averaged net DEP force resulting from the MST method is:

$${F}_{DEP} = \frac{1}{4} Re ( {\tilde{ɛ}}_{m} ) {∮}_{A} ( ( \vec{E} {\vec{E}}^{*} + {\vec{E}}^{*} \vec{E} ) - {\vert E \vert}^{2} U ) . \qquad ( 5 )$$

where A is the surface area of the probe, \vec{E} is the electric field outside the probe and U is the unit tensor. Both methods showed convergence to constant force values for mesh sizes below 25 nm. After we integrated the MST over the surface, we multiplied the resulting force by the maximum real part of the CM factor, which is equal to 1 for positive DEP and 0.5 for negative DEP. We found that the MST method produced very similar results for all models; forces for full 3D round and square well models agreed within 3-8%, whereas reduced 3D or 2D models were different from the full 3D results by 15-20% of the total force (with a potential varied between 1 and 10 V and electrode separations varied between 20 and 100 μm). In contrast, the EDA method, which assumes a slowly varying electric field (compared to the probe size), overestimated the forces by a factor of 1.8 (reduced 3D) or 5 (full 3D) with respect to the MST results. Since the results between the full and reduced 3D methods showed adequate agreement in the magnitude of forces, we used the reduced 3D method in all simulations unless otherwise noted.

Fabrication of the DEP chip

The general strategy of fabricating an array of wells on a cover glass is shown in SI, Fig. S3. A round (40 mm diameter) cover glass (Warner Instruments, MA) was cleaned in Piranha solution (a 3:2 mixture of 98% H₂SO₄: 30% H₂O₂) for 40 minutes. The cover glass was rinsed with deionized (DI) water and blown dry with filtered nitrogen. Titanium (4.5 nm) and gold (11 nm) films were deposited on the glass surface using an e-beam evaporator (Eddy Co. SYS-24, SC-20-Digital System Controller). The gold-coated cover glass was then cleaned by air plasma (Harrick Plasma, Ithaca, N.Y.) on a high power setting for 1 min. SU-8 3005 resist (Microchem Co., MA), was used to construct wells of desired depth and size on the gold-coated cover glass following the procedure recommended by the manufacturer. The SEM image in Figure S4 shows the final microwell pattern having straight sidewalls and a flat bottom. The cell compatible with TIRF observations required two extra fabrication steps. In order to block the light from propagating in the SU-8 and interacting with the probe, a 130 nm gold film was first deposited instead of the 11 nm gold layer (using the e-beam evaporator). We calculated that the transmission of light through 130 nm gold layer is less than 0.1%. After exposure and development of the SU-8 pattern, the thick gold layer at the bottom of the well was etched using a standard gold etchant (4 g Kl, 1 g I₂, and 80 mL DI-H₂O). as confirmed by transmission microscopy (SI, Figure S4). A final thin transparent gold film (4 nm titanium and 15 nm gold using an e-beam evaporator) was deposited, coating primarily the bottom of the well and the top of the SU8 resist, for use with the thiol-on-gold immobilization chemistry. The initial gold layer under the SU8 will block the light from reaching any probe that may reside on the surface of the resist.

Probe Fabrication and Activation

Our ssDNA oligomer was 142 base pairs long (82 nm) and produced in-house using standard ligation techniques. The model DNA contained 5′-amine and 3′-thiol end modifications (5′—NH₂—(CH₂)₆— TG TAG AGA CGT CGA CAG CTC ACA CTC GCA TAC GAG ACT ATA GTA CGT ATC GAT ACG TCA TCT GAT CAC GCA CGC ATA TGT AGA GCT AGT GAG CAC GTC GAT ATG ACA TGA TAG CAG TCG CTA GGT CAG ATC GTT CGA CTA GG —(CH₂)₃—S—S—CH₂CH₂OH-3′). The sequence was constructed in order to eliminate as much secondary structure as possible by randomly generating sequences with certain limitations. Namely, no repeats of any particular base more than three times in a row were allowed.

To create a 142mer ssDNA terminated with an amine on the 5′ end and a thiol group on the 3′ end, a 5′-amine terminated 71mer, a 3′-thiol terminated 71mer, and a 30mer complementary to 15 bases at non-modified ends of each 71mer (purchased from Integrated DNA Technologies) were annealed, and the 71mers were then ligated together. First, 4.5 μL of 1 mM aqueous solutions of each DNA oligo were mixed with 10 μL of an annealing buffer (100 mM Tris HCL, 1M NaCl, 10 mM EDTA) and diluted to 100 μL with autoclaved DI water. The solution was denatured by undergoing a heat cycle of 2 min at 95° C. in a thermocycler (Techne TC-3000) followed by five cycles of 95° C. for 15 s, 40° C. for 15s, and 72° C. for 60 s. At the end of the last cycle the system was annealed for 5 min at 72° C. This procedure resulted in 45 μM of DNA in a 100 μL solution. For ligation, 50 μL of the DNA solution were combined with 14 μL of 10×T4 ligase buffer and 18.75 μL of T4 DNA ligase (7500 units) (New England Biosciences), diluted to 150 μL with autoclaved DI water, and kept at 16° C. for 16 hours in the thermocycler. The product of ligation was separated from reaction mixture using a MinElute column (Qiagen) and eluted with 10 μL DI water. The DNA was purified from the 30mer and other side-products by a 6×TBE Urea gel (Invitrogen). After excising the band, the sample was eluted with 1×TBE buffer at 37° C. overnight. The final product was purified with a MinElute column and eluted with 20 μL. of DI water. The final DNA concentration was 50 ng/μL (˜1 μM).

Substrate Preparation

The microwells were cleaned with air plasma for 1 minute, then placed in an ethanol bath for 10 min on a shaker table and finally dried with nitrogen. A self-assembled monolayer was formed by reacting a 1 mM aqueous solution of (11-mercaptoundecyl)tetra(ethylene glycol) (MutEG) with the Au substrate for 1 hour followed by a thorough DI water rinse. For single molecule stretching experiments with ssDNA, 1 μL of 1.5 μM solution of 142mer ssDNA was first unprotected by adding 4 μL of 5 mM tris(2-carboxyethyl)phosphine in 6×SSC buffer and incubating for 30 min. A competitive binding was then used to attach the DNA at a low density by placing 10 μL (5 μL of each) of 1:100 or 1:150 142mer ssDNA (mixture from previous step): MutEG (dissolved in 1 M NaCl PBS) mixture on the substrate for 2 hours. The DI water rinsed and nitrogen dried substrate was then incubated in 1 mM MutEG solution for another hour.

DEP Cell Assembly and Microscope Setup

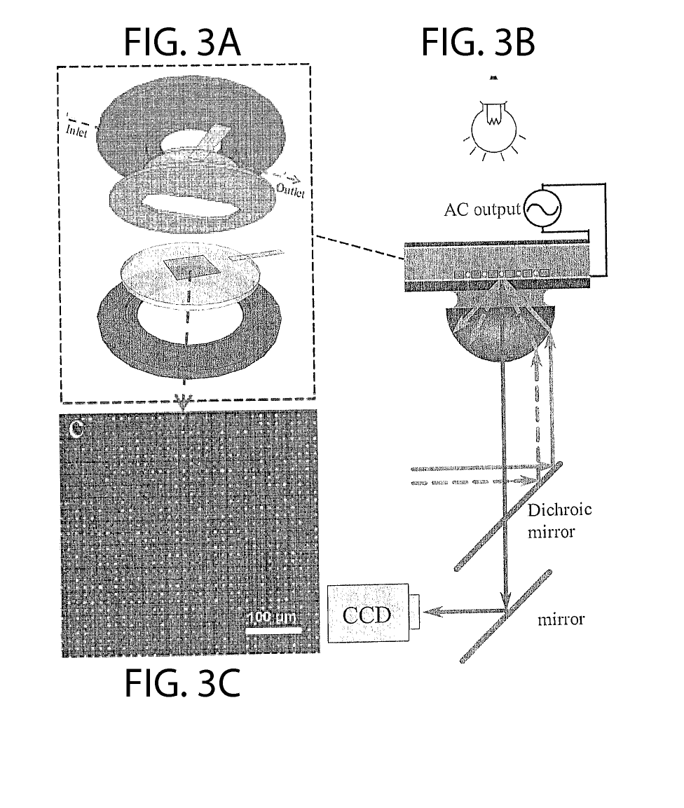

The substrates were installed on the bottom side of a commercially available fluid cell (RC30, Warner Instruments) and a plasma cleaned flat gold substrate is installed on the top plate and sealed with vacuum grease (FIG. 3a). A 30 mm long copper foil tape (32 μm thickness) was attached to the surface of each electrode. The top-plate and the bottom-plate were sealed together with a silicone gasket leaving a 100 μm gap. The two electrodes were then connected to a function generator (Model 645-G, BNC Co., CA). The cell was set onto a stage of the through-objective TIRF microscope (Olympus IX 71, equipped with 638 nm fiber optic coupled diode laser, (Coherent), FIG. 3b). An excess of probes were added to the cell using an inlet port. The probes were then allowed to settle via gravity and those that did not occupy the wells were washed away. A fluorescent microscopy image (FIG. 3c) showed more than 80% occupancy of the micro-wells after the probes were infused into the assembled fluid cell.

For non-specific binding experiments, the probes were suspended in 0.1% solution of TWEEN 20 in DI water or phosphate buffer (pH 7.4) at 1 or 10 mM total ionic strength and flushed into the microfluidic cell. For the frequency scan experiment on a flat substrate, the probes settled down close to the surface by gravity. A frequency sweep with different scan rates under a constant potential was applied to the two electrodes while a video was captured by a CCD camera (Andor Technologies, iXon DV888, Belfast, Ireland). The number of probes and the integrated intensity of individual probes were calculated from analysis of the videos using custom code written in Igor Pro 6.2 (WaveMetrics, OR). Initial probe locations were found by thresholding the image and then (more accurately) from a fit to a 2-D Gaussian function. For each probe, a circular region of interest (ROI) was set around the center of the probe at a diameter of 10 rpm (approximately five times the FWHM of the probe intensity profile). For each ROI, the background was first subtracted using a plane fit to a 1 μm-wide band surrounding the ROI. Probe intensities were then computed by numerical integration over the ROI. For ssDNA single molecule stretching experiment, the NHS-activated probes were flushed into the cell and settled down in the wells by gravity. The probes were incubated for 10 min inside the wells in order to attach to the ssDNA molecules (FIG. 3b). A sinusoidal potential modulation was applied to the two electrodes to stretch the DNA while a video was recorded.

FIG. 3 shows: (a) DEP cell assembly and (b) setup in an optical microscope. The microwell pattern (green) is fabricated on top of the Au-coated glass cover slip (yellow). A sample is sealed with an elastomeric gasket (orange) against Au-coated electrode (yellow) and both are connected to a function generator via copper foil (rectangular yellow pieces). (b) The illumination in transmission mode helped to identify the edges of the microwells. CCD camera captures fluorescent images of the probes from a commercial TIRF setup integrated with a 638 nm laser. (c) Microscope image (10×) of the fluorescent probes assembled inside the microwells.

### Results and Discussion

Molecular force spectroscopy provides information about a molecule's intra- and intermolecular forces through the measurement of force-distance profiles. The simulations and experiments described in this paper sought to determine the applicability of our DEP setup as a standalone force spectroscopy technique for parallel measurement. Three common aspects of force spectroscopy are usually considered: (i) a high force magnitude (>1 nN) in a controllable direction (compression or extension), (ii) high force resolution (˜1 pN), and (iii) sensitive detection of molecular extension (<1 nm). We addressed each of these aspects with respect to critical factors such as applied voltage, electrode separation, frequency of applied field, probe position, and microwell geometry.

Voltage Dependence of DEP Force

One can vary the DEP force exerted on the probe by adjusting potential difference between the two electrodes (F_{DEP}˜V², Equation 1). We computed the DEP force for flat electrodes (Geometry A) through the MST integration by sweeping peak-to-peak voltage from 0 V to 10 V for the planar electrode cell (SI, Figure S7). The results of the numerical analysis indicated an excellent agreement with the formal voltage dependence (a power law exponent of exactly 2) expected from the approximate model (Equation 1). Therefore, modulation of the DEP force can be readily achieved via the electrode potential. Using this method the force resolution would be defined by the resolution and stability of the driving electronics (according to Equation 1, for the simulated design, the relative noise in applied force should stay constant throughout voltage sweep, δF/F=2δV/V, and 1 mV RMS noise will correspond to a 0.2 pN resolution at 10 V and 10 fN at 1 V). Since the shape of the field gradient is set by the geometry of the setup and the local field scales with voltage, this voltage dependence of the DEP force holds for all other chip designs, as we confirmed by simulations of the DEP force on probes placed in 4 μm deep microwells (see SI, Figure S7).

Effect of the Spacing Between Two Electrodes

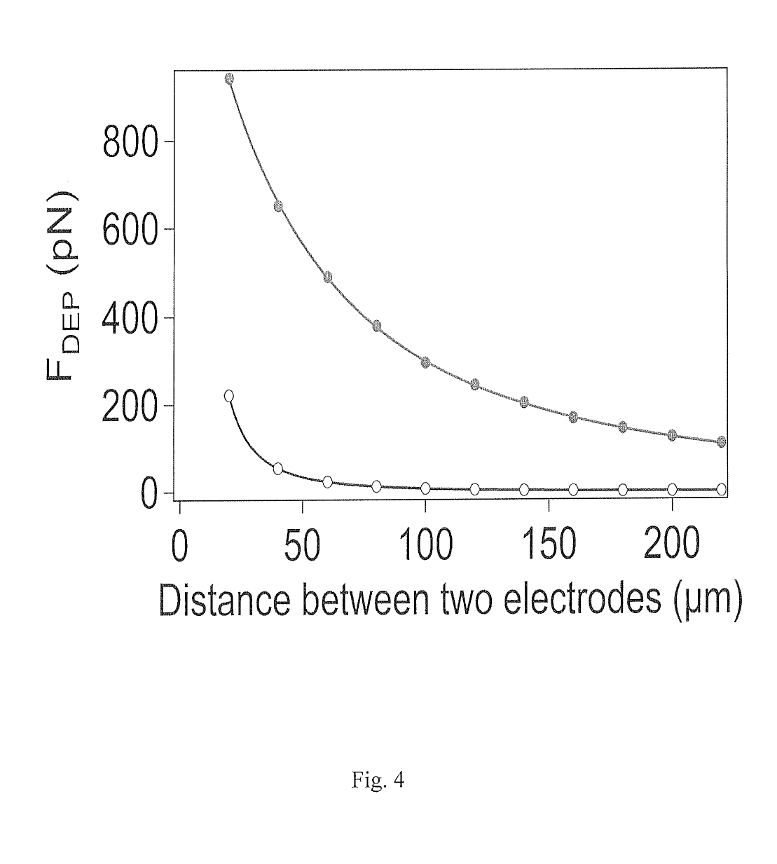

At a fixed potential difference, the magnitude of the electric field, E, in the space confined by the large area electrodes depends on their separation, s (for parallel electrodes in Geometry A, E∝1/s and F_{DEP}∝E∇E∝1/s²). We found that the magnitude of the DEP force quickly decays with increasing distance between the two electrodes for both flat substrates and microwell designs. According to our simulations, for a 20 μm separation between electrodes, the DEP force of several hundred piconewton is readily achieved with both flat and micropatterned electrode configurations. For flat electrodes (Geometry A), the applied force dropped by two orders of magnitude, from 450 pN to 4 pN, (FIG. 4) when the separation between electrodes increases from 20 μm to 200 μm. In contrast, when we placed a 3 μm diameter probe inside a 4 μm deep microwell (Geometry C, FIG. 2c), the calculated force decreased gradually from 980 pN to 80 pN when electrodes moved apart from 20 μm to 200 μm.

FIG. 4 shows simulation results of DEP force as a function of the electrode separation for probes placed 50 nm above the surface of a flat substrate (O), Geometry A, or the bottom of the microwell (). Geometry C. The parameters used for the simulation were 10 V peak-to-peak voltage with a 3 μm diameter probe. The curves represent the power law F_{DEP}∝1/sⁿ for a Geometry A, where n=1.987±0.001, and the square of a function in Eq. 6 for a Geometry B.

By fitting the DEP force decay for flat electrodes to a power law (FIG. 4), we determined that 1/s² relationship fits this decay precisely, implying that for large electrode separations (s<<R) the distribution of the electric field in this geometry does not change with the electrode gap (i.e. E(z,s)≈V/(s f(z)), where function f(z) characterizes electric field distribution for all s). For the microwells, the fit unexpectedly deviates from the F_DEP (∝1)ŝ2 form (we obtained a best-fit exponent of 0.600±0.033). We inspected numerical values of the electric field in the system and determined that this deviation is a result of our two layer arrangement (SU-8 and water). Since we are effectively using two parallel dielectrics in our system, the relative contributions (to the overall voltage between electrodes) of potential drops across each layer change with gap size causing a deviation from the expected power law. This effect is not present in a one-layer system. The electric field in the SU8 layer in this capacitor is:

a. ∈_resist=V/(s ∈_resist/∈_{—}m+h(1+—resist/∈_{—}m)) (6)

where ∈_resist is the dielectric constant of photoresist and ∈_m is the dielectric constant of medium. By fitting the decay precisely, implying that for large electrode separations (s<<R) the distribution of the electric field in this geometry does not change with the electrode gap (i.e. E(z, s)≈V/s f(z), where function f(z) characterizes electric field distribution for all s). For the microwells, the fit unexpectedly deviates from the F_{DEP}∝1/s² form (we obtained a best-fit exponent of 0.600±0.033). We inspected numerical values of the electric field in the system and determined that this deviation is a result of our two layer arrangement (SU-8 and water). Since we are effectively using two parallel dielectrics in our system, the relative contributions (to the overall voltage between electrodes) of potential drops across each layer change with gap size causing a deviation from the expected power law. This effect is not present in a one-layer system. The electric field in the SU8 layer in this capacitor is:

$${E}_{resist} = \frac{V}{s \frac{{ɛ}_{resist}}{{ɛ}_{m}} + h ( 1 + \frac{{ɛ}_{resist}}{{ɛ}_{m}} )} \qquad ( 6 )$$

where ∈ᵣₑₛᵢₛₜ is the dielectric constant of photoresist and ∈ₘ is the dielectric constant of medium. By fitting the decay in the graph to the square of this function we see that the observed decrease in the DEP force follows a decay law related to the magnitude of the electric field in the resist.

The results from FIG. 4 demonstrate that the DEP tweezers have a limitation on the maximum achievable force, requiring close proximity between the electrodes to attain a measurable DEP force. Although the force generated with a 20 μm gap for both flat and patterned electrodes is sufficient for most applications in force spectroscopy, the fabrication, handling, and storing components of such a device will pose some challenges. For example, it is hard to fabricate and handle a 20 μm thick elastomeric gasket to seal the DEP cell for fluid delivery. Therefore, to ensure an adequate range of forces (˜100 pN) for Geometry A, the seal must be fabricated into one of the electrodes. On the other hand, the microwell geometry is not as sensitive to electrode separation and gaskets as thick as 100-200 μm appear suitable for a DEP cell, simplifying assembly of the microfluidic cell. For example, we successfully used a commercial fluid cell that places a polymer gasket between top-plate and bottom-plate to seal the system.

Frequency Dependence of the DEP Forces

Within any one of the DEP tweezers geometries, the microspheres can be pulled away from the surface or pushed towards the surface by switching between positive and negative DEP. Both regimes are readily achievable by operating at an appropriate frequency of the AC field (FIG. 1). Since the CM factor is a property of the probe and the medium only, we used the simplest electrode setup of two parallel plates to determine the crossover frequency. Using flat electrodes (Geometry A), dispersed probes were allowed to settle onto the surface of the bottom electrode via gravity and then (i) either a stepped potential (0 to 10V) was applied to the cell at a fixed frequency or (ii) the potential was held constant (Vₚₚ=10 V) while modulating the frequency from 1 MHz to 1 kHz. Using TIRF detection, with a 70° angle of incidence, we captured movies of the probes present near sample surface (probes lifted from the surface by the DEP force into bulk solution do not fluoresce due to TIR illumination conditions).

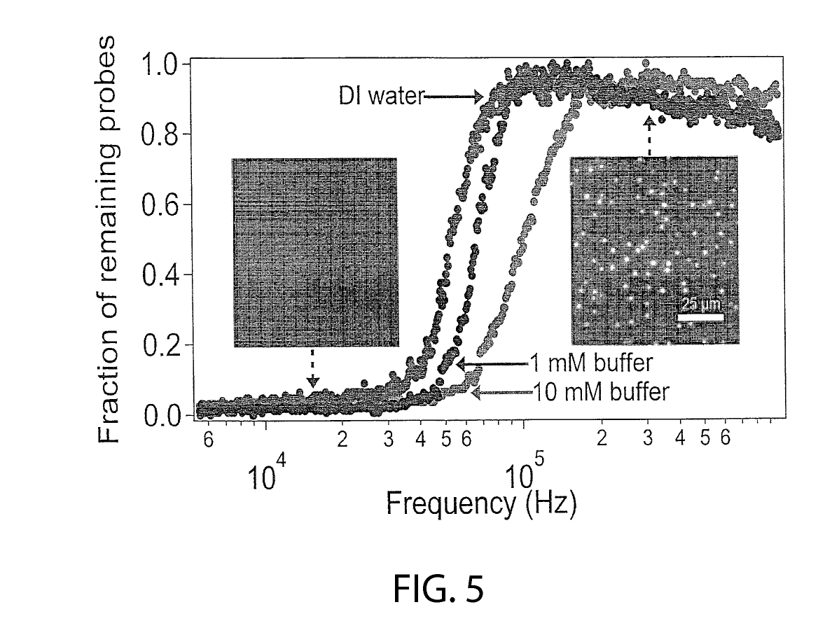

Without an applied voltage, the probe population remained suspended some distance (up to 200 nm) above the surface trapped in a potential well formed by the repulsive double layer forces and attraction due to gravity. In this state, the thermally activated movement of the probes in the soft potential well resulted in significant fluctuations in intensity (comparable to their mean intensity). When the high frequency (>100 kHz) field was applied, the probe fluorescence became more intense (FIG. 5—right inset) and fluctuations in intensity were reduced, indicating that the DEP force drove the probes toward the surface. Conversely, when the field was applied at a low frequency (<10 kHz), the intensity of the fluorescence dropped to zero, indicating the probes were driven off the surface completely (FIG. 5—left inset). Thus, positive DEP moves the polymer beads away from the flat electrode, whereas negative DEP attracts them to the surface.

FIG. 5 shows the number of polystyrene microspheres remaining on the surface of the electrode as the frequency of the applied AC field is changed from 1 MHz to 1 kHz in DI water or phosphate buffer. The number of probes is normalized to the maximum detected during a given sweep. In the negative DEP regime (high frequency), the number of probes slowly increases in the course of the experiment as more probes approach the surface from the bulk of the solution and accumulate at the surface due to attractive DEP forces. (left inset) TIRF image of a sample of probes when 10 V potential is applied at 200 kHz. The probes overcome the electrical double layer repulsion and land on the surface when the field is turned on. The intensity is high, indicating a close proximity to the surface. (right inset) Image of the same sample at a frequency of 10 kHz (10 V potential). Probes are no longer visible using TIRF microscopy.

In order to acquire the full frequency response of the probes in our system, we continuously monitored the number of probes in the vicinity of the surface (using TIRF) over the course of a frequency sweep at three different ionic strengths. The results shown in FIG. 5 represent the changes of the CM factor with frequency of the AC field in our system. The crossover between positive and negative DEP occurs at between 50 and 100 kHz and depends on the bead's surface (electrical double layer) conductivity, which changes with the ionic strength of the buffer. The method we describe here was highly reproducible (2-3% error for crossover frequency obtained in repeated experiments), independent of the rate of frequency sweep (between 1 and 4 decades per minute). Unlike the use of quadrupole electrodes, optical trapping or patterned electrodes, our method is very straightforward to implement under different solution conditions for beads of various compositions and properties. Any proposed design of DEP tweezers can be quickly evaluated for the frequency dependence of the directionality of the force by carrying out a frequency sweep experiment with probes having inert chemistry (to ensure that they contact the surface of the electrode in a fully reversible manner). For example, we determined experimentally that microwells having a depth greater than the bead diameter (Geometry C) result in repulsion from the surface under positive DEP conditions (low frequency), whereas microwells with depths smaller than bead diameter (Geometry B) display attractive forces under the same conditions.

Changes in the DEP Force Magnitude with Position of the Probe

With single molecule force spectroscopy, one could study specific binding events (i.e. breaking of intermolecular contacts) as well as conformational changes and stretching of biopolymers (DNA and proteins) that could require a force probe to move by as much as 100-1000 nm, depending on the contour length of the biomolecule. Since field inhomogeneity is produced by microscopic features, changes in the DEP force experienced by probes moving near the surface of the electrode constitute an important characteristic in the design of the DEP tweezers.

Normal Forces.

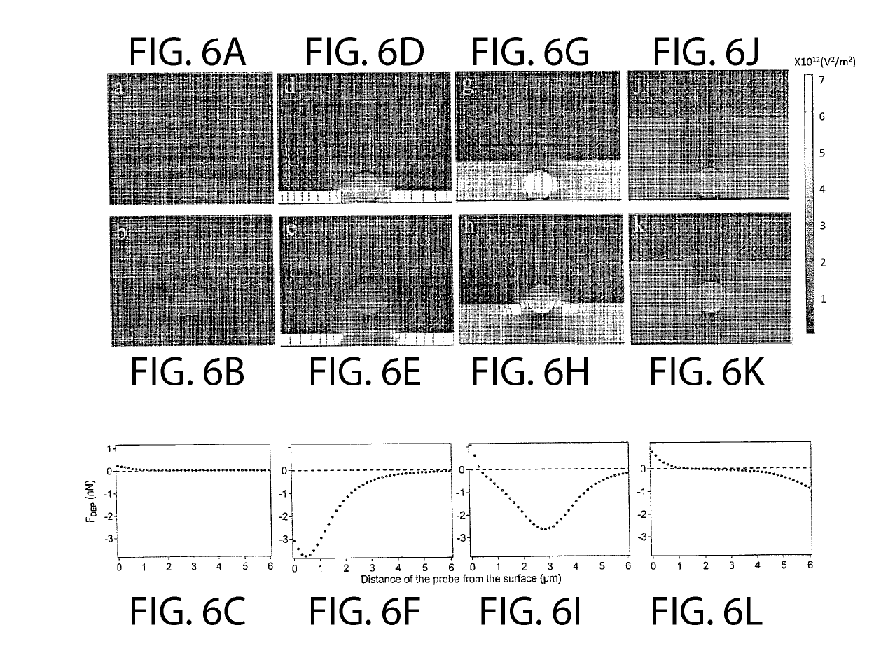

When a dielectric probe is placed between the two planar electrodes, the probe itself induces inhomogeneity in the electric field. Numerical calculations show a difference in the density of electric field lines above and below the probe in contact with the electrode (FIG. 6a). The overall electric field is higher at the top half of the probe than at the bottom, so that the probe will move away from the electrode under conditions of the positive DEP, as indeed observed in our experiments (FIG. 5). When the probe is displaced away from the surface, the asymmetry is gradually lost as the electric field intensity above and below the probe becomes balanced (FIG. 6b), resulting in no net DEP force as expected for a dielectric probe suspended in a uniform electric field. The DEP force drops down to one half of its maximum value within 1 μm from the surface.

Once the probes are placed inside the microwells, the contrast in the intensity of the electric field around the probes markedly increases (FIG. 6c-f) leading to forces higher than for a probe near a non-structured interface. For shallow wells (Geometry B), the high field is concentrated near the edges of the well. As a result, at any distance from the surface, the parts of the probe facing the sample experience a higher field than the parts facing the solution. This situation is opposite to what we found for flat electrodes (Geometry A). The DEP cell with shallow microwells (Geometry B) will produce a repulsive force at negative DEP (high frequency). Indeed, a voltage step from 0 to 1 V at 1 MHz results in the removal of the 3 μm probes from 1 μm deep wells in our experiments.

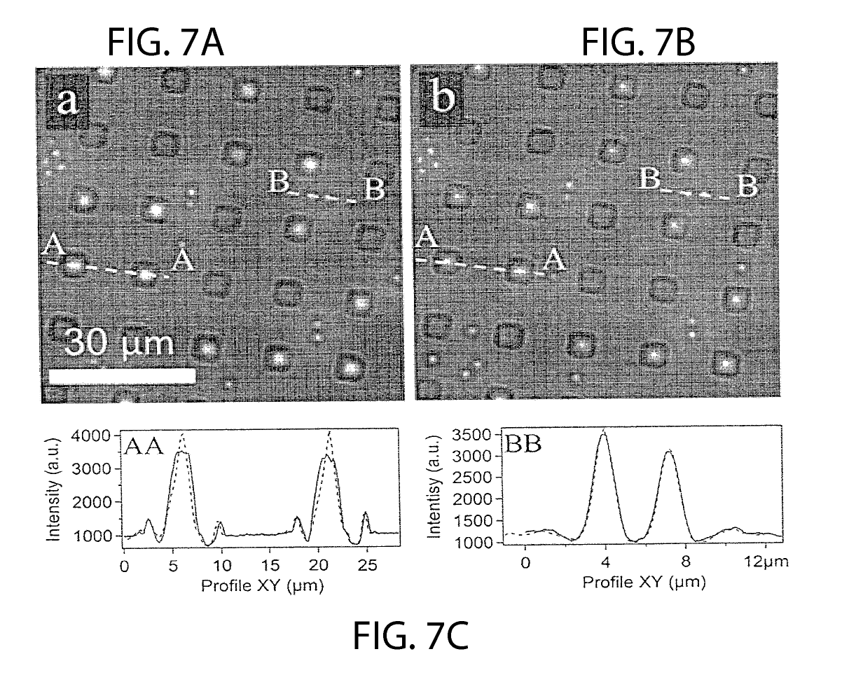

When the depth of a microwell exceeds the size of the probe (Geometry C), the overall force profile represents a superposition of two opposing effects (i) a decrease of the electric field between the probe and electrode surface and (ii) an increase of the field around the edges of the well. For positive DEP (low frequency), surface at small bead-electrode separations (<0.5 μm for a 4 μm deep well), whereas the force is attractive at large separations. For such a geometry, the probes can be trapped inside the well at some stable vertical position elevated above the surface, representing potential energy minimum for positive DEP (FIG. 6i, I). Experiments with this design produced a stable trapping position for 3 μm diameter microspheres inside the microwells as demonstrated with far-field epi-fluorescence. (FIG. 7). The probes inside the well moved out of the focus, but stayed inside the wells, when the frequency was changed from 100 kHz to 1 kHz. In contrast, the intensity profiles of the beads on top of the SU8 layer show perfect overlap at 100 kHz and 1 kHz as expected for stationary probes, since now realignment was done during frequency shift.

The competition between the two effects results in a quicker decay of the force with distance than for planar electrodes. The DEP force drops down to one half of its maximum value within 200-400 nm from the surface for 4-8 μm deep wells. On the other hand, the maximum force experienced by the probe in contact with the surface more than doubles compared to the flat electrode (Geometry A) due to the concentration of the field inside the microwell containing the buffer solution having a higher polarizability than the adjacent photoresist.

The change of the force with increase of the probe separation from the electrode is a potential drawback of the DEP tweezers, since, in addition to calibration with respect to applied voltage and probe size for a given microwell design, the forces need to be measured or calibrated at every position of the probe. This requirement, however, is not substantially different form the need to measure forces at every experimental point in the force-distance curves obtained using common force spectroscopy methods such as AFM or optical tweezers. In principle, one can calibrate forces in DEP tweezers using thermal fluctuations in the probe position with either x-y or z tracking^{47,48} as is done for magnetic or optical tweezers. Since according in our simulations, the DEP force appears linear with respect to bead-surface

FIG. 6 shows electric field distributions in Geometry A (a-c), Geometry B (d-f), and Geometry C (g-I) for a 3 μm diameter probe at 50 nm (a, d, g, and j) and 3 rpm (b, e, h, and k) above the surface of the electrode. When close to the surface, the probe is pulled up (F_{DEP}>0) by the positive DEP force in (a), (g), and (j), and by the negative DEP in (d). The red streamlines represent the electric field. The surface plots are E² and all six graphs share the same scale. (c), (f), (i), and (I) The DEP forces versus distance from the surface when the 3 μm probe is moving away from the electrode.

Surface at small bead-electrode separations (<0.5 □m for a 4□m deep well), whereas the force is attractive at large separations. For such a geometry, the probes can be trapped inside the well at some stable vertical position elevated above the surface, representing potential energy minimum for positive DEP (FIG. 6i, I). Experiments with this design produced a stable trapping

FIG. 7 Epi-fluorescence images of the probes assembled in wells with Geometry C. (a) The probes are pushed toward the surface by a negative DEP force at high frequency (100 kHz) and (b) levitated above the surface by a positive DEP force at low frequency (1 kHz) (Vpp=10 V). The probes go slightly out of focus as indicated by their intensity profiles (c) when the frequency is switched from high (a) to low (b). Small bright spots are beads settled on top of the SU-8 surface between wells. Their positions do not change (c). The solid lines in (c) represent the profiles for 100 kHz AC field, while the dashed lines correspond to 1 KHz.

Position for 3 μm diameter microspheres inside the microwells as demonstrated with far-field epi-fluorescence. (FIG. 7). The probes inside the well moved out of the focus, but stayed inside the wells, when the frequency was changed from 100 kHz to 1 kHz. In contrast, the intensity profiles of the beads on top of the SU8 layer show perfect overlap at 100 kHz and 1 kHz as expected for stationary probes, since now realignment was done during frequency shift.

The competition between the two effects results in a quicker decay of the force with distance than for planar electrodes. The DEP force drops down to one half of its maximum value within 200-400 nm from the surface for 4-8 μm deep wells. On the other hand, the maximum force experienced by the probe in contact with the surface more than doubles compared to the flat electrode (Geometry A) due to the concentration of the field inside the microwell containing the buffer solution having a higher polarizability than the adjacent photoresist.

The change of the force with increase of the probe separation from the electrode is a potential drawback of the DEP tweezers, since, in addition to calibration with respect to applied voltage and probe size for a given microwell design, the forces need to be measured or calibrated at every position of the probe. This requirement, however, is not substantially different form the need to measure forces at every experimental point in the force-distance curves obtained using common force spectroscopy methods such as AFM or optical tweezers. In principle, one can calibrate forces in DEP tweezers using thermal fluctuations in the probe position with either x-y or z tracking 47, 48 as is done for magnetic or optical tweezers. Since according in our simulations, the DEP force appears linear with respect to bead-surface

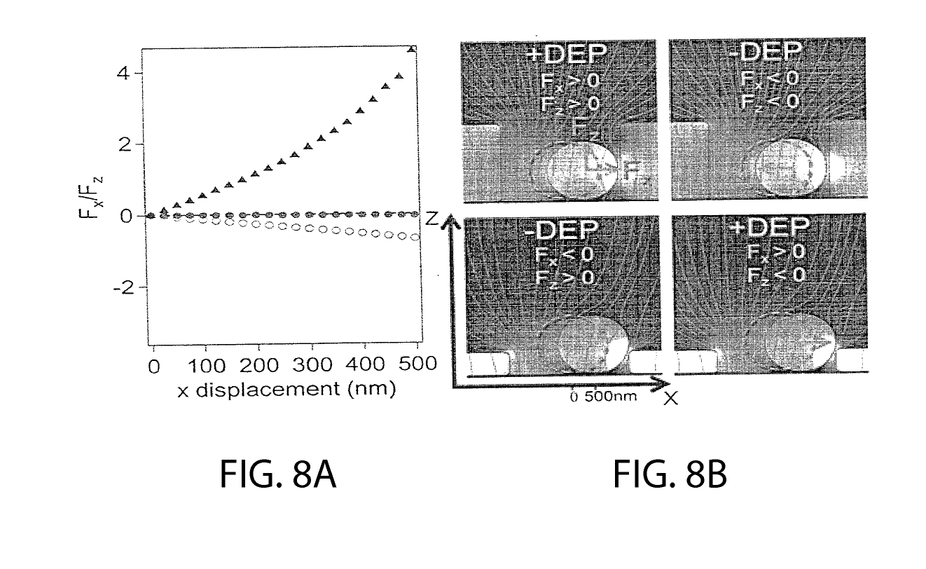

FIG. 8 (a) shows (a) the ratio of lateral forces to normal forces as functions of lateral displacement of the probes from the well axis for microwell DEP cell with Geometry B (FIG. 2b, Δ), Geometry C (FIG. 2c, ◯), and Geometry D (FIG. 2d, ). (b) Blue dashed outlines show the centered position of the probes and the blue arrows show the direction of the normal and lateral forces acting on the probe in each situation (positive or negative DEP). These forces were calculated using a 2D well to reduce calculation time.

Separation at displacements below several hundred nanometers, one can also derive the DEP forces by calibrating this linear correlation; thus, only applied voltage and probe-surface distance will be required for the calculation of the DEP force experienced by the probe.49

Lateral forces. One can expect an imbalance of the electric field distribution, if the bead is not centered laterally in the microwell for Geometries B-D. A smaller gap between the probe and the wall results in a higher field intensity. This uneven electric field produces a lateral force that pulls the probes towards the wall during positive DEP and repels them from the wall under negative DEP conditions (FIG. 8). Force spectroscopy operates by pulling the bead away from the surface, thereby stretching the attached molecule. In deep wells (Geometries C & D), a stretching force is applied using positive DEP, while shallow wells (Geometry B) use negative DEP.

Inspecting the relative magnitude of normal and later forces (FIG. 8a), we observe that for deep wells it is crucial to have the probes properly centered, whereas some misalignment can be tolerated for shallow wells. Nevertheless, use of the deep wells may be preferred to shallow wells, because the required alignment can be achieved in the course of the attachment step by application of the negative DEP to trap the bead in the microwell (negative DEP traps and centers the probe in this case,). The probe will be axially centered by lateral forces at negative DEP (see FIG. 8b) and its position fixed by the molecule attached between the electrode and the probe. Alternatively, one can make the top surface of the pattern conductive as well (by the second metal coating step) as in the DEP cell with Geometry D (FIG. 2d). This cell produces no noticeable lateral force (FIG. 8a) and centering of the bead inside the well becomes unimportant.

Measurements of Molecular Extension

The z-position of a microsphere near surface could be found using analysis of images from reflectance interference microscopy 50 or TIRF microscopy. 47, 51, 52 Both methods are compatible with flat electrodes, however, for structured electrodes, TIRF microscopy is preferred because only total intensity of the probe fluorescence or scattering intensity is needed to map the vertical position of the probe.53 We used through-objective laser TIRF in our experiments with DEP tweezers. To achieve TIR conditions at the bottom of the microwells, the incident laser beam must be prevented from entering the SU-8 resist layer, since otherwise propagating light conditions will be achieved effectively throughout the whole sample. A thick metal layer between the glass substrate and resist layer in the DEP cell design shown in FIG. 2d (Geometry D) serves this purpose (see SI, Figure S5).

Stretching of Single Stranded DNA Molecules Using DEP Tweezers

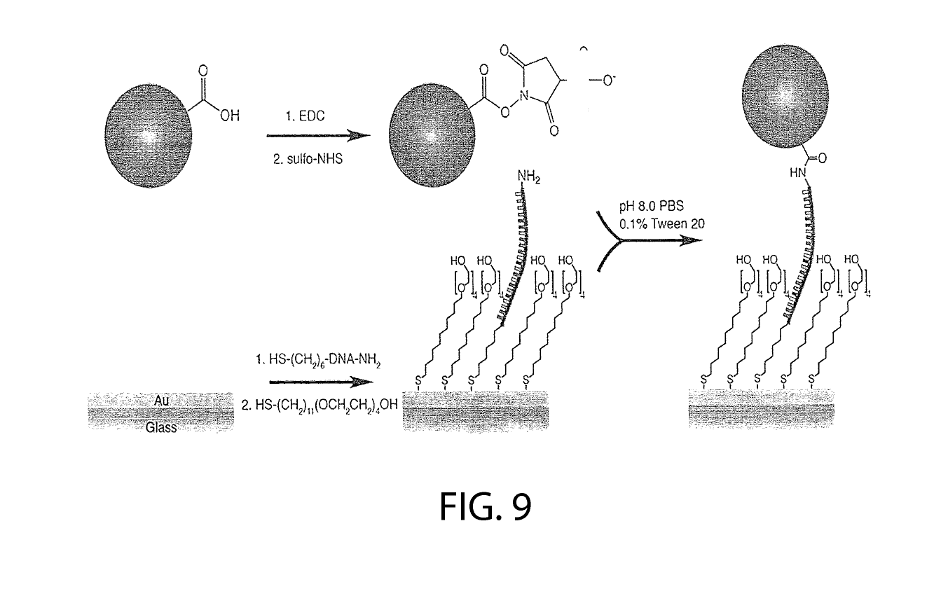

To demonstrate the ability of the proposed DEP tweezers to conduct single molecule force spectroscopy, we used a model system of ssDNA. We tethered the DEP probe to the surface via a 142 base long DNA oligomer using the reaction scheme depicted in FIG. 9. 49 The synthetic sequence contained two different

FIG. 9 illustrates a reaction scheme of the probe and ssDNA attachment to gold electrode.

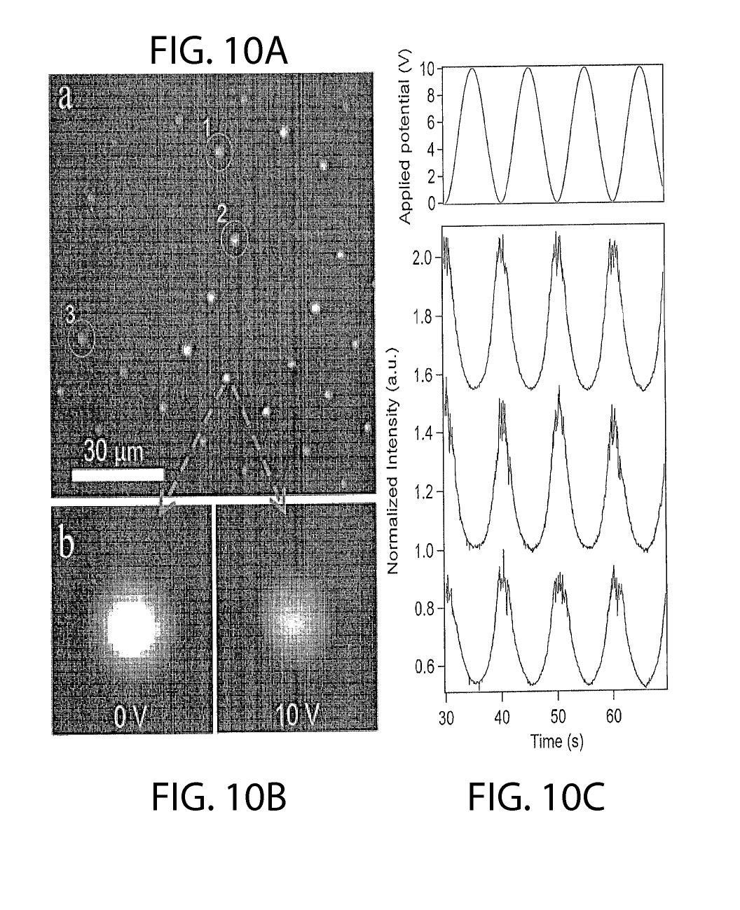

Terminal functional groups (thiol and amine) to facilitate attachment chemistry to gold electrode and poly(methyl methacrylate) microspheres bearing surface carboxyl groups. After the beads were flushed into the fluid cell and tethered to ssDNA molecules attached to the bottom of the wells, about 80% of the wells were occupied with the force probes (FIG. 10a). After attachment of probes, we applied a 1 kHz AC field to electrodes in the DEP fluid cell (Geometry D, FIG. 2d, see Figure S8 for force decay plot) and modulated the peak-to-peak voltage between 0 V and 10 V to stretch the DNA. When the AC field was applied, about 25% of the captured probes left the surface, indicating that these probes were not covalently bound to the ssDNA. The remaining probes showed intensity oscillations when we modulated the amplitude of AC voltage. At low forces (low voltage amplitude), the DNA is compact and probes are close to the surface of the electrode (i.e. the interface for TIR). As the voltage amplitude is ramped up, the probes move away from the surface, extending the DNA molecules. As expected for TIRF illumination, the fluorescence of the beads is brighter at low voltage than at high voltage (compare images in FIG. 10b). The fluorescence intensities of the beads that move away from the surface at high voltage amplitude decay about 50% on average. According to the force-extension curve of ssDNA molecule, the estimated DEP force exerted on a probe is between 15 and 25 picoNewtons. 49

The TIRF-illumination images of the probes in FIG. 10a show a wide distribution of intensities. This variation can be attributed to a number of factors: (i) non-uniform particle size, (ii) differences in the lateral positions of probes in the wells, and (iii) a non-uniform (Gaussian) illuminating intensity distribution in the field of view. We have measured a moderate polydispersity of probes sizes (up to a factor of two difference in diameters) and, since the fluorescence intensity is proportional to the volume, this polydispersity can yield up to an order of magnitude difference in brightness. The probe position and the light distribution of the probe inside the well are related. Simulations show an uneven lateral distribution of light inside the wells (FIG. S9), which decreases in intensity as the probes move closer to the edges. Finally, it may be possible that the thick gold layer on the bottom of the well is not fully etched for every well, thus blocking an unknown percentage of the illumination and emission of the probes.

FIG. 10 shows: (a) TIRF image extracted from a movie of the beads bound to ssDNA molecules attached at low density at the bottom of the wells. The image was taken at 0 V (i.e. when the probes were closest to the surface). (b) When the AC voltage amplitude changes from 0 V to 10 V, the brightness of the probe drops approximately 50%, consistent with the probe being pulled away from the surface and the DNA molecule being stretched. (c) Applied potential and raw fluorescence intensity data (normalized to a maximum intensity observed in a given trace) versus time for three beads circled in part (a). Intensity traces are shifted with respect to each other for clarity.

We are able to record movies of active probes (those that exhibited a change in intensity upon application of force) and record multiple force-extension curves for an array of the DNA molecules. As can be seen from the time traces of the total fluorescence intensity shown in FIG. 10c, the force-extension curves for individual molecules are very reproducible and one can acquire high-quality data from multiple molecules in parallel. In this particular frame, 27 force probes populated 50 microwells and most of them showed the behaviour expected for single molecule stretching (only a few produced changes in intensity consistent with multi-tether attachment). The current DEP tweezers setup can already be used in qualitative analysis, for example, in the case of the ssDNA used here, to detect binding of the DNA-binding proteins or hybridization with a complementary oligomer, Quantitative force spectroscopy will require proper calibration of forces and bead-surface distances as well as the light intensity field in the microwells, all of which are the focus of our on-going work with this system.

### CONCLUSIONS

We herein describe a new single molecule force spectroscopy method based on dielectrophoresis—DEP tweezers. Numerical simulations suggest that forces on the order of 1 nN can be readily achieved with a 10 V peak-to-peak AC voltage applied to a DEP cell. The direction of the force can be switched by selecting the frequency regime appropriate for either positive or negative DEP. The parallel-plate electrodes DEP cell design can serve as a simple device to map the crossover frequency between the two DEP regimes for different probes and solution conditions without setting up the quadruple electrodes or integrating the DEP device with the optical tweezers.

There are several disadvantages to this method of manipulation of the force probes: (i) DEP forces acting on a colloidal probe decay quickly with its distance from the electrode (within 200-500 nm); (ii) the maximum force achieved in the DEP tweezers drops rapidly (inversely quadratic) with an increase in the inter-electrode gap; and (iii) forces need to be measured or calibrated independently for each position of the probe. Some of these difficulties can be alleviated by using microstructured electrodes; for example, microwells can increase the maximum force on the beads and greatly reduce the dependence of the DEP force on the inter-electrode spacing. Microwell arrays can have added benefits for DEP tweezers by increasing the density of the probes on the surface, simplifying bead indexing, and improving stability of the probe-molecule assembly by reducing shear forces during exchange of the solution inside the fluid cell. The final assembled instrument was applied to stretching of the ssDNA molecules and demonstrated reproducible operation in stretching single DNA molecules.

We have examined a variety of chip geometries for highly parallel force spectroscopy, each with its own set of advantages and limitations. We feel that, with the selection of geometries described in this paper, most applications involving some form of force application should be amenable to DEP tweezers. For applications where the applied force must be known quantitatively (such as in protein unfolding or DNA stretching) a middle ground must be reached between the magnitude of the forces and complexity of the cell design and data analysis. One has to compromise between small variations in the magnitude of the forces (less than an order of magnitude) due to positioning and size, and the need for an individual calibration of the forces on each probe in order to measure the forces in an arbitrary system. Refinement of the uniformity of the experimental implementation of the DEP tweezers (e.g. use of symmetrical round wells and monodisperse probes) can also alleviate the issues of device calibration. As opposed to the microwell geometry, the planar electrode produces more uniform forces across the entire working area making it easier to directly compare the results of adjacent probes at the expense of reduced force magnitude and the need for slower fluid exchange. If both conditions are required (high forces and a calibrated force magnitude) one can use the microwell geometry with a force calibration based on the Brownian diffusion of the probes under applied force.

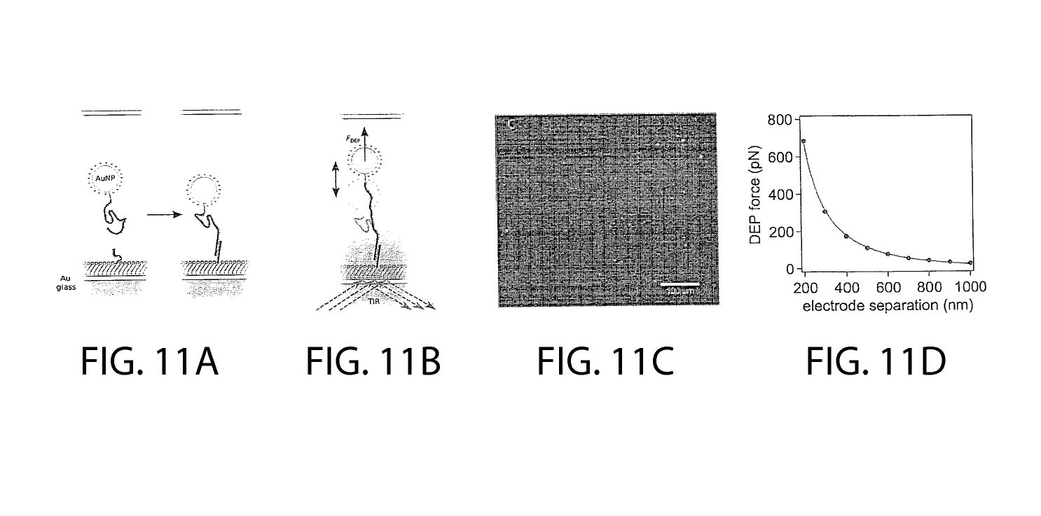

Reducing the size of force probes. Most methods in SMFS rely on micron-sized colloidal probes because the force scales with the volume of the probe (which in turn scales with radius as R3). DEP tweezers provide an opportunity to scale down the size of the force probe significantly by reducing the dimensions of the device while preserving the massively parallel SM manipulation and detection. Reducing the distance between the two parallel-plate electrodes to around 1 μm, enables us to pull on single gold nanoparticles with >20 pN of force in parallel (see simulation result in FIG. 11d), a force regime which is comparable to most magnetic tweezers setups. The attachment of the gold nanoparticles as a force probe is similar to attachment to colloidal probes (FIG. 11a&b), with two important simplifications. (1) the gold nanoparticle is easily modified with thiolated DNA, requiring no activation chemistry and (2) the size of the gold nanoparticle is commensurate with the hydrodynamic radius of the DNA strand itself (15-20 nm). The similarity in size between the gold nanoparticle and the DNA strand significantly reduces the possibility of making multiple tethers between the probe and the surface. Furthermore, the small size of the nanoparticles reduces nonspecific binding of probes to the substrate and completely eliminates issues associated with shear flow. In spite of the gold nanoparticles' small dimensions, we found that they scatter very brightly (several orders of magnitude brighter than the background) under TIR illumination (FIG. 11c), and fluctuate in intensity as their Brownian motion brings them closer or farther away from the surface. We expect scattering of these gold nanoparticle tethers to provide us with highly accurate nanometric measurements of extensions for single molecules in a way previously unprecedented in the SMFS community.

FIG. 11 illustrates SMFS using gold nanoparticles in a DEP fluid cell. (a) Gold nanoparticles, functionalized with the target DNA strand, are added to a surface containing cDNA. (b) After hybridization, a DEP force can be used to stretch the single DNA strand, while measuring its extension using TIR-scattering from the gold nanoparticle. (c) Experimental image of a dilute solution of 17 nm diameter gold nanoparticles in a fluid cell (20× magnification, TIR-illumination). Their intensity fluctuates as they move closer or farther away from the glass/water interface. (d) Simulation of the forces applied to the gold nanoparticles as a function of electrode separation.

The investigators continue to develop the methods and apparatus for DEP described herein, including for manipulation of cells to enrich ultralow density populations for application to cell sensing and detection. There are several commonly used techniques for single cell manipulation encountered in literature. A single cell can be manipulated by the AFM (single-cell force spectroscopy 13): either a cell bound on an AFM tip is brought in contact with a surface (or other cell) in studies of cell adhesion, or a cell bound to the surface, is indented by an AFM tip to study mechanical properties of cells. Although this technique, as well as optical tweezers, 54 offers single cell manipulation with great precision, only one cell can be studied at a time. Another common approach is immunoassay-based selection. 55 In this method, cells are flown into a fluidic chamber over surfaces modified by specific receptors. A highly selective population of cells can be captured, but the landing pattern of the cells is random and detection is often slow.

Fluidic flow is sometimes employed to select cells based on their size. 56, 57 Channels of different size can enrich cells of a particular diameter, independent of any specific biomarkers. Changing the flow profile using microstructured wells or posts leads to another label-free method, 58-60 but it is relatively slow for separation and the efficiency of trapping is low. Thus, hydrodynamic methods cannot be readily used in sensing or diagnostic applications that require cell counting. Single cell manipulation in a sequence of nanoemulsion droplets is another label-free method, 61 but is effectively one-dimensional, having relatively long processing times, which significantly lowers the throughput.

Dielectrophoresis manipulation is an attractive alternative to the listed methods for single-cell manipulation. Currently, the use of microstructured electrodes offers great speed and efficiency for single-cell trapping, 62-65 but it is hard to scale up (to many cells) and package for routine laboratory and commercial uses. The proposed DEP tweezers described above can serve as new type of label-free electrode-less method that can be coupled with a specific immunoassay; be fast, highly-parallel, scalable, easy to fabricate; and offer several modes of optical detection.

Application to sensing and diagnostic devices: CD4+ cell counting. A lab-on-a-chip device is one of the most promising methods to deliver HIV point-of-care diagnostics to the area with limited resources and in the absence of skilled health workers. There has yet to be a commercially viable mobile chip-based HIV detection device on the market. Accurate CD4+ cell counting is known as a rapid HIV diagnosis method. 55 Here we propose to investigate our micro-wells based DEP setup as basis for the development of a low cost, rapid, and automated CD4+ cell-counting device.

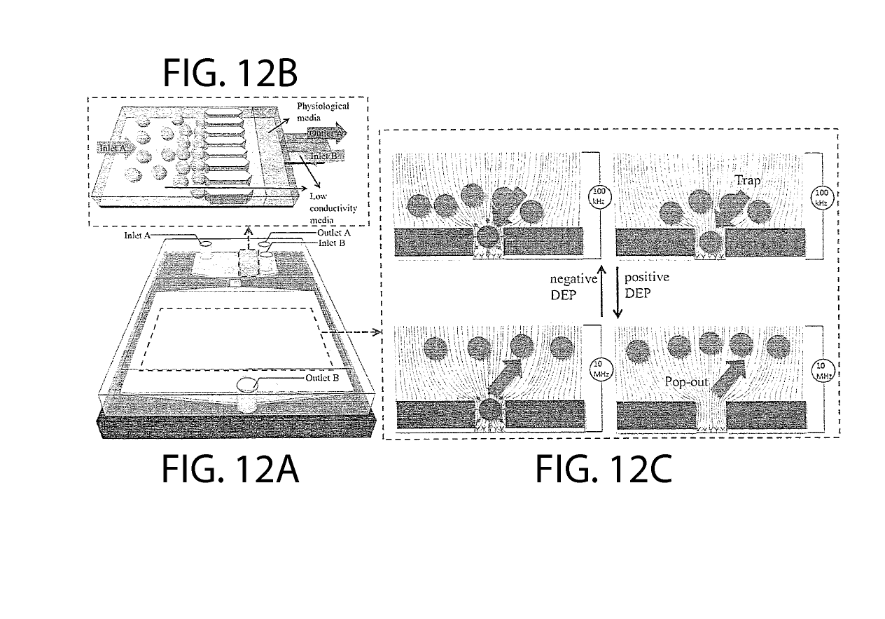

The potential design of such a device is shown in FIG. 12. FIG. 12 (a) illustrates the microfluidic chip in a cell counting device has two major components. First part of the design integrates microfabricated posts (b) acting as a filter in exchange of the physiological media for a low conductivity media. (c) The microwells, fabricated on the second region of the chip, trap specific cells (red) in the course of cycling between positive DEP and negative DEP The physiological sample is first injected in a small fluid exchange device and then the cells suspended in the low conductivity media are flushed into the cell counting region. A fluid exchange step before cell-counting is required. An activated positive

DEP force is needed to remove the un-bound cells from the wells for fast detection. A well-known difficulty for positive DEP manipulation of cells is the requirement of a low conductivity sample medium, when most physiological samples have high conductivities over 1 S/m. A multi-electrode chip employing a lateral DEP force to exchange the cells from a high to low conductivity media has been described. 66 Here, we propose an alternative method of changing the buffer conductivity. As shown in FIG. 12a, the physiological sample can be followed by a low conductivity buffer solution injected in the same inlet. The cells are blocked by the micro-fabricated posts as the physiological media flows into the outlet A. After the cell media has been totally exchanged, the same low conductivity buffer is injected into inlet B and the cells are re-suspended in the low conductivity media and moved in the micro-wells region for analysis. The bottoms of the wells are modified with biotinylated anti-human CD4 monoclonal antibody (we will use the difference in surface chemistry of glass and resist to conjugate antibodies at the bottom of the wells only). When the cells are forced into contact with the bottom of the wells by negative DEP, the CD4+ cell will be immobilized, but not the other cells in the suspension. We will then apply positive DEP by switching the frequency so that the unbound cells will pop-out of the wells, whereas the target CD4+ cells will remain attached. After multiple cycles to capture most CD4+ cells, one can count the cells using dark field illumination—only the wells occupied with CD4+ cells will be bright. The major advantage of the proposed tool is the implementation of an active transport of cells to and from the sensing surface, greatly enhancing the rate of cell capture.

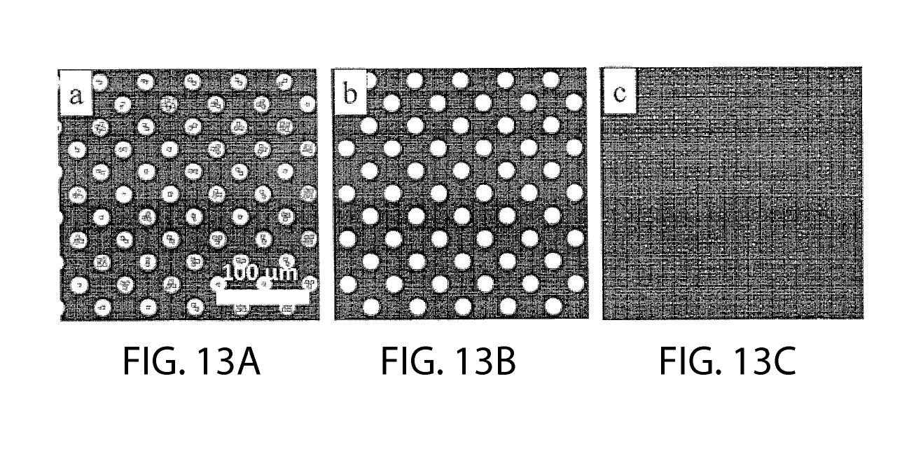

Preliminary demonstration of principle for cell trapping: trapping and releasing polymer beads. We trapped and released polymer microspheres in a proof-of-concept experiment. The suspension of 5.9 μm polystyrene microspheres in 10 mM phosphate buffer with 0.1% Tween20 was flushed inside the fluid cell having an integrated microwells substrate. FIG. 13 (a) A bright field (transmission) image of the 5.9 μm polymer microspheres trapped in the 20 μm micro-wells when a constant 10 V at 100 kHz was applied between two electrodes. (b) When we applied a constant 10 V at 1 kHz, all beads left the wells. (c) The 3.0 μm polymer microspheres that were fluctuating inside the wells were observed using dark field illumination under 100× objective. The dark field illumination is set up using wave guiding through the microscope slide and compound microscope with standard objectives. The bright dots represent the beads at the bottom of the wells illuminated by evanescent wave. As shown in FIG. 13a, the beads were trapped inside wells when applying 10 V at a 100 kHz frequency. The experimental result matches our numerical calculations (FIG. 1 and FIG. 5). The beads were trapped in the center of the well by applying negative DEP to the system. We noticed that multiple beads can be trapped in the same well in an equilibrium packing arrangement (singlets, doublets, and other multiplets), since they all tend to move towards the center of the well. When we switched the negative DEP to positive DEP (by applying 10 V at 1 kHz), all the beads popped out of the wells (FIG. 13b). FIG. 13c shows that beads sitting inside the micro-wells illuminated by dark field illumination are much brighter than the background from the wells. An increase in brightness indicates a closer bead-surface separation.

CD4+ cells in low conductivity solution. As one might expect, CD4+ cells behave differently from polymer microspheres. We calculated the real part of CM factor for the CD4+ cell using protoplast model:

Re(CM)=−(ω̂2(T_{—}1 T_{—}m−T_{—}c T_{—}m̂′)+iω(T_{m̂′-}T_{—}1−T_{—}m)−1)/(ω̂2(T_{—}c T_{—}m̂′+2T_{—}1 T_{—}m)+iω(T_{—}m̂′+2T_{—}1+T_{—}m)−2) (7)

where T_m=c_m R/σ_c, T_c=∈_c/94 _c, T_{—}1=∈_{—}1/σ_{—}1 and T_m̂′=c_m R/o_{—}1. c_m is the cell membrane capacitance. ∈_{—}1 and σ_{—}1 are the dielectric constant and conductivity of the medium. ∈_c, σ_c and R are the dielectric constant, conductivity and radius of the cell respectively.67.

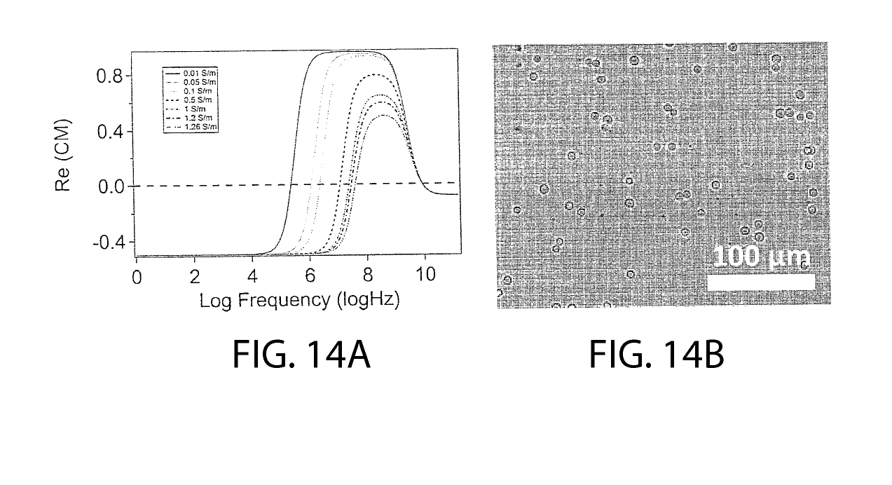

FIG. 14 (a) The real part of CM factor of cells suspended in aqueous solution is a function of frequency and medium conductivity. When the medium conductivity increases, the first crossover frequency shifts to higher values and the maximum positive value of CM factor decreases. (b) The stained cells were observed under 10× objective. No cells showed blue staining in this field of view.

As shown in FIG. 14a, when the conductivity of the medium is 0.01 S/m, which is about 1 mM NaCl, positive DEP can be approached and the highest force can be archived at a frequency of 1 MHz. When the media's conductivity is 1.2 S/m, a 50 MHz frequency is required for the system to apply positive DEP. We tested the CD4+ cell viability in various low conductivity media by staining the cells with Trypan blue (a dead cell stain). Since the osmolarity of CD4+ cell is 280 mM, we added 250 mM sucrose to the low salt concentration solutions to maintain osmotic stability. We found that almost all of the cells (close to 100%) stayed alive in a 100× dilution of RPMI-1640 growth media of CD4+ cell with 250 mM sucrose solution for more than one hour. (FIG. 14b). Therefore, we should be able to use the proposed system to capture these cells using properly modified microwells in our DEP tweezers device. We continue to explore explore the rate of enrichment using various cycling conditions and cell dilutions. In control experiments, non-specific well modification and nonspecific cell lines will be used. The methodology proposed here is quite general and can be readily extended to other cell-antibody pairs by anyone skilled in the art, without departing from the invention as described and claimed herein.

Chasing the limits of detection. Trapping of viruses directly is an attractive approach for point-of-care detection of HIV and other diseases. Current HIV tests can give false results in the “window period”, which is the time between HIV infection and the body's production of antibodies. Direct measurement of a virus can reduce the time required to provide a diagnosis. We found out that 17 nm gold nanoparticles can be easily observed with dark field illumination under 20× objective (FIG. 11c). According to simulations, pico-Newton negative DEP forces can be applied to nanoparticles and hold the nanoparticle close to the surface between two flat electrodes when the electrode separation is 1 μm. The target viral particles, just like cells, could be captured on the surface with specific chemistry in order to speed up enrichment of their surface concentration to enable detection. Since, in principle, the proposed method is sensitive to single particles, the detection of a few (10-100) viral particles per sample (nL) seems quite feasible. Fluidic exchange (required for reducing the conductivity of the buffer) for a viral particle will be difficult to fabricate given its nanoscopic dimensions. However, simple dilution with deionized water may prove viable (the net result being a lower maximum surface density).

1. A method of performing force spectroscopy, the method comprising the steps of providing dielectrophoretic tweezers having at least one set of macroscopic electrodes, at least one of the electrodes having a microfabricated dielectric structure comprising a microwell; depositing force probes on a surface; binding the force probes to molecules on the surface; and applying voltage across set of macroscopic electrodes to thereby manipulate the molecules.

2. The method of claim 1, wherein the macroscopic electrodes comprise parallel flat electrodes configured to manipulate an array of polymer microspheres (force probes).

3. The method of claim 2, wherein the molecules are biomolecules.

4. The method of claim 3, wherein the bio molecules comprise DNA, and wherein the environment of the probes approximates a physiological condition.

5. An apparatus for performing force spectroscopy, the apparatus comprising comprising dielectrophoretic tweezers having at least one set of macroscopic electrodes, at least one of the electrodes having a microfabricated dielectric structure comprising a microwell.
